(19) United States
(12) Patent Application Publication
(10) Pub. No.: US 2016/0249634 A1
(43) Pub. Date: Sep. 1, 2016

(54) TEA DRINK

(71) Applicant: KIRIN BEVERAGE KABUSHIKI KAISHA, Nakano-ku, Tokyo (JP)

(72) Inventors: Takashi SHIONO, Tokyo (JP); Kenichiroh YAMAMOTO, Tokyo (JP); Hiroyuki NAGANUMA, Tokyo (JP); Hiroyuki SHINOHARA, Tokyo (JP); Azusa KUDO, Tokyo (JP)

(73) Assignee: KIRIN BEVERAGE KABUSHIKI KAISHA, Tokyo (JP)

(21) Appl. No.: 15/032,664

(22) PCT Filed: Aug. 7, 2014
(86) PCT No.: PCT/JP2014/070939

§ 371 Date: Apr. 28, 2016

(30) Foreign Application Priority Data
Oct. 31, 2013 (JP) 2013-227373

(51) Int. Cl. A23F 3/38; A23F 3/16

(52) U.S. Cl. CPC A23F 3/38; A23F 3/16

(57) ABSTRACT

Provided is a tea drink which contains at least a polyphenol, calcium and choline, and wherein the content of the polyphenol contained in 100 mL of the tea drink is 10 to 40 mg in terms of tannins, the content of caffeine contained in 100 mL of the tea drink is 2.0 mg or less and the calcium/choline ratio in the tea drink is 3 to 65. This drink is a tea drink in which a content of polyphenol is maintained within a fixed range and a content of caffeine has been reduced and after-astringency of the drink is improved.

### CROSS REFERENCE TO RELATED APPLICATION

This application claims the benefit of Japanese Priority Application JP 2013-227373 filed on Oct. 31, 2013, the entire contents are incorporated herein by reference.

### FIELD OF THE INVENTION

The present invention relates to a tea drink, in more detail, to a tea drink that contains at least a polyphenol, calcium, and choline.

### BACKGROUND ART

Regarding caffeine contained in a tea drink or coffee drink, while there are consumers who want to positively take in to suppress sleepiness by a pharmacological action, there are also consumers who care possibility of being disturbed from sleeping or have difficulty in getting to sleep due to caffeine intake and back away from a caffeine-containing drink, in particular, a tea drink or coffee drink.

A method aiming at obtaining a uniform and stable residual caffeine amount by heat treatment of tea leaves is studied (see, for example, Patent Document 1). However, a tea drink obtained according to this method may have a taste from which a flavor such as bitterness or astringency is lost.

Further, there is proposed a green tea drink in which, by subjecting a tea extract liquid to various processes, while reducing an amount of caffeine, richness of sweet fragrance and umami remains (see, for example, Patent Document 2). Still further, there is proposed a green tea drink in which deficiency of flavor intrinsic to a tea is eliminated by setting a ratio of content of tannin to caffeine to 30 or more (see, for example, Patent Document 3).

### BACKGROUND ART DOCUMENTS

### Patent Documents

Patent Document 1: JP H07-135902 A
Patent Document 2: JP 2011-155877 A
Patent Document 3: JP 2008-113569 A

### SUMMARY OF THE INVENTION

The present inventors have studied hard about a tea drink, wherein the content of polyphenol is maintained within a fixed range and after-astringency of the tea drink having a reduced content of caffeine is improved.

The present inventors have found a problem that, when a process for reducing the content of caffeine contained in a tea extract liquid (decaffeination process) is performed, not only the caffeine concentration in the tea drink is reduced but also bitterness, astringency, and after-astringency that are important flavor intrinsic to the tea drink are reduced, and in particular, in the refreshing-flavored tea drink containing relatively less polyphenol, the after-astringency is remarkably reduced. In the tea drink, a balance between the bitterness and the astringency is an important factor that forms the flavor. The after-astringency, unlike bitter astringency, which is a negative astringency close to the bitterness and mere astringency sensed when drinking, is a particularly important flavor, giving thickness and lingeringness, for consumers to judge the flavor of the thin-tasted tea drink containing relatively small amount of polyphenol and having refreshing flavor. Suppressing the reduction of the after-astringency accompanying the reduction of the caffeine concentration in the refreshing-flavored tea drink containing a relatively small amount of polyphenol enables consumers to sense the tea-intrinsic flavor while considering health-consciousness of consumers.

It is an object of the present invention to provide a tea drink, wherein a content of polyphenol is maintained within a fixed range and after-astringency of the tea drink having a reduced content of caffeine is improved.

The present inventors have found that in the tea drink, wherein the after-astringency of the tea drink can be improved by maintaining a content ratio of calcium to choline within a fixed range in the tea drink having the content of polyphenol within a fixed range and the reduced content of caffeine. The present invention is based on these findings.

That is, according to the present invention, the following inventions are provided.
(1) A tea drink comprising at least polyphenol, calcium and choline,
   wherein the content of the polyphenol contained in 100 mL of the tea drink is 10 to 40 mg in terms of tannins,
   wherein the content of caffeine contained in 100 mL of the tea drink is 2.0 mg or less, and
   wherein the ratio of calcium to choline contained in the tea drink is 3 to 65.
(2) The tea drink according to (1), wherein the content of calcium contained in 100 mL of the tea drink is 0.1 to 30 mg.
(3) The tea drink according to (1) or (2), wherein the content of choline contained in 100 mL of the tea drink is 0.01 to 5.0 mg.
(4) The tea drink according to any one of (1) to (3), wherein the pH of the tea drink is 5.5 to 8.5.
(5) The tea drink according to any one of (1) to (4), wherein the tea drink is a green tea drink.
(6) The tea drink according to any one of (1) to (5), wherein the tea drink is a packaged tea drink.
(7) A method of manufacturing a tea drink from a tea extract liquid, comprising the steps of:
   adjusting the content of polyphenol in the tea extract liquid to a value corresponding to 10 to 40 mg in terms of tannins in 100 mL of the tea drink;
   adjusting the content of caffeine in the tea extract liquid to a value corresponding to 2.0 mg or less in 100 mL of the tea drink; and
   adjusting calcium and choline in the tea extract liquid such that the ratio of calcium to choline is 3 to 65 in the tea extract liquid.
(8) A tea drink manufactured by the method according to (7).
(9) A method of improving after-astringency of a tea drink, characterized in that the content of polyphenol in a tea extract liquid is adjusted to a value corresponding to 10 to 40 mg in terms of tannins in 100 mL of the tea drink, the content of caffeine in the tea extract liquid is adjusted to a value corresponding to 2.0 mg or less in 100 mL of the tea drink, and calcium and choline in the tea extract liquid are adjusted such that the ratio of calcium to choline is 3 to 65 in the tea drink.

The present invention has the advantage that it provides a tea drink, wherein the content of polyphenol is maintained within a fixed range and after-astringency of the tea drink having a reduced content of caffeine is improved. Further, the tea drink of the present invention does not necessitate a special apparatus necessary when using an organic solvent, and has an advantage of being capable of conveniently providing the tea drink at low cost.

### DETAILED DESCRIPTION OF THE INVENTION

The tea drink of the present invention is a tea drink that contains at least polyphenol, calcium, and choline. In the tea drink, the content of polyphenol contained in 100 mL of the tea drink is 10 to 40 mg in terms of tannins, the content of caffeine contained in 100 mL of the tea drink is 2.0 mg or less, and a ratio of calcium to choline contained in the tea drink is 3 to 65. The after-astringency of the tea drink, wherein the content of polyphenol is maintained within a fixed range and the content of caffeine is reduced, can be improved.

The tea drink of the present invention can be manufactured by the method comprising the steps of:

adjusting the content of polyphenol in a tea extract liquid to a value corresponding to 10 to 40 mg in terms of tannins in 100 mL of the tea drink;

adjusting the content of caffeine in the tea extract liquid to a value corresponding to 2.0 mg or less in 100 mL of the tea drink; and
adjusting calcium and choline in a tea extract liquid such that a ratio of calcium to choline is 3 to 65 in the tea drink. The content of polyphenol, the content of caffeine, and the ratio of calcium to choline in the tea drink can be adjusted by reducing and increasing according to the following description.

Tea leaves used in a tea extract liquid that is used to manufacture the tea drink of the invention are not limited to particular one. That is, the tea leaves that belong to Camellia sinensis can be used, and not only non-fermented teas such as green tea leaves such as sage tea, high-quality green tea, green powdered tea, kiln-dried tea, coarse tea, and Hojicha, but also half-fermented tea such as oolong tea, fermented tea such as black tea, and post-fermented tea such as pu-erh tea can be used. The tea drink of the invention is preferably a green tea drink.

As the tea extract liquid used in the invention, not only the tea extract liquid extracted from the above-described tea leaves, but also commercially available tea extracts or powders such as Polyphenon (manufactured by Mitsui Norin Co., Ltd.), Sanphenon (manufactured by Taiyo Chemical Co., Ltd.), and THEA-FLAN (manufactured by ITO-EN) can be used. These extracts or powders may be used by dissolving in water or hot water, further, these concentrated tea extracts and purified tea extracts may be used singly, in a mixture of a plurality of kinds, or as a mixture with the tea extract liquid.

The polyphenol contained in the tea drink of the invention means a component having a plurality of phenolic hydroxyl groups in a molecule. The polyphenol contained in the tea drink of the invention is preferably polyphenol derived from tea. The polyphenol derived from the tea indicates various polyphenols contained in the tea leaves, and specifically is used in the meaning including not only primary polyphenols such as catechins and proanthocyanidins but also secondary polyphenols such as theacynensins, oolong theanine, theaflavins, and thearubigins, which are products due to oxidation polymerization of the primary polyphenols.

In the tea drink of the invention, the content of polyphenol can be defined in terms of an amount of tannins. In the tea drink of the invention, “the amount of tannins” can adjust the content of polyphenol contained in the tea drink within the predetermined range by measuring the amount of tannins in a tea leaf extract liquid and/or a tea extract and making the amount of tannins within a desired concentration range. Alternatively, the amount of tannins in a product drink can be adjusted also by adding a predetermined amount of the tea leaf extract liquid and/or tea extract having the amount of tannins adjusted in advance, thus, the content of polyphenol contained in the tea drink can be adjusted.

In the present invention, the “amount of tannins” can be measured by using a tartaric acid iron method (see Toshio Nakabayashi et al. “Chemistry and Function of Green Tea, Black Tea and Oolong Tea” Kougaku Shuppan, p.137) that is a standard for evaluating the amount of polyphenol in tea. In this measurement method, by measuring absorptivity (540 nm) of a violet component generated by reacting polyphenol in the liquid and a tartaric acid iron reagent, a quantitative measurement can be performed using a calibration curve prepared with ethyl gallate as a reference substance. The amount of tannins can be obtained by multiplying 1.5 on thus obtained quantified value.

Polyphenol contained in 100 mL of the tea drink of the invention is 10 to 40 mg in terms of tannins, preferably 15 to 35 mg, and more preferably 20 to 30 mg.

The tea drinks of the invention can be manufactured according to a usual method used for manufacturing tea drinks. The content of caffeine, content of calcium and content of choline in the tea drink of the invention can be adjusted according to a heretofore known method.

In the tea drink of the invention, caffeine contained in 100 mL of the tea drink of the invention is 2.0 mg or less, preferably 1.5 mg or less, more preferably 1.0 mg or less, and still more preferably less than 1.0 mg. The content of caffeine in the tea drink can be measured according to a high performance liquid chromatography method (HPLC method). As a measurement condition of the high performance liquid chromatography method (HPLC method), measurement conditions that are illustrated in, for example, Examples of the present specification can be used.

The content of caffeine in the tea drink of the invention can be adjusted by reducing, for example, by sprinkling tea leaves with hot water or water, by dipping tea leaves in hot water or water, or by using tea leaves extracted with supercritical carbon dioxide gas, during tea manufacture. Further, the content of caffeine in the tea drink of the invention can be also adjusted or reduced by extracting the tea drink from tea leaves at a low temperature or by using the extract liquid after second extraction. Still further, the content of caffeine in the tea drink can be also adjusted or reduced by processing the tea extract liquid with an absorbent such as activated carbon or a resin or a mineral such as white earth. These methods for reducing the content of caffeine may be used singly or in combination. On the other hand, when the content of caffeine in the tea drink of the invention is to be increased, a caffeine preparation acceptable for food can be added. The caffeine preparation can be added, for example, in a final compounding step of the extract. As the caffeine preparation, for example, Caffeine (manufactured by Shiratori Pharmaceutical Co., Ltd.) can be used.

In the tea drink of the invention, the content of calcium contained in 1000 mL of the tea drink is not particularly limited as long as the ratio of calcium to choline contained in the tea drink of the invention is 3 to 65, but is preferably 0.1 to 30 mg, more preferably 1 to 20 mg, and still more preferably 5 to 10 mg. The content of calcium in the tea drink can be measured according to an ion chromatography method. It should be noted that the content of calcium in the tea drink corresponds to an amount of free calcium. As measurement conditions of the ion chromatography method, measurement conditions that are illustrated in, for example, Examples of the present specification can be used.

In order to increase the content of calcium in the tea drink of the invention, a calcium source acceptable for food can be added to the tea extract liquid to adjust the content of calcium. As the calcium source acceptable for food, for example, organic acid salts of calcium, inorganic acid salts of calcium, and organic salts of matters in calcium can be used. When these are added to the tea extract liquid, the content of calcium in the tea drink of the invention can be increased. Further, when a mineral such as white earth or its processed matter which discharges calcium ions on contact with the tea extract liquid is brought into contact with the tea extract liquid, the content of calcium can be also increased. On the other hand, in order to reduce the content of calcium in the tea drink, there is a method in which, for example, a negative ion which makes calcium salt insoluble is added to precipitate and remove calcium as a salt. Further, the content of calcium can be also reduced by processing the tea extract liquid using the absorbent such as an ion exchange resin, a chelate resin or the like. However, when the tea extract liquid is processed with an absorbent, not only calcium but also caffeine or the like may be removed. In this case, it is desirable to adjust the content of caffeine and the content of calcium within a range of a predetermined value by adding either one or both of the components as required.

As the organic acid calcium capable of being added to the tea drink of the invention, for example, calcium ascorbate, calcium gluconate, calcium lactate, calcium citrate, calcium stearate, calcium sorbate, calcium pantothenate, and calcium propionate can be used. Further, as the inorganic acid calcium capable of being added to the tea drink of the invention, for example, calcium chloride, calcium phosphate, calcium glycerophosphate, calcium silicate, calcium hydroxide, calcium carbonate, and calcium sulfate can be used. Still further, as the organic matters in calcium salt form capable of being added to the tea drink, for example, L-calcium glutamate can be used.

In the tea drink of the invention, the content of choline contained in 1000 mL of the tea drink is not particularly limited as long as the ratio of calcium to choline contained in the tea drink of the invention is 3 to 65, but is preferably 0.01 to 5.0 mg, more preferably 0.05 to 1.0 mg, and still more preferably 0.1 to 0.5 mg. The content of choline in the tea drink can be measured according to a high speed liquid chromatography-mass spectrometry method (LC/MS). As measurement conditions of the high speed liquid chromatography-mass spectrometry method, measurement conditions that are illustrated in, for example, Examples of the present specification can be used.

In order to increase the content of choline in the tea drink of the invention, a choline source acceptable for food can be added to the tea extract liquid to adjust the content of choline. For example, the content of choline can be increased by adding, for example, a tea extract containing choline chloride or choline. On the other hand, in order to reduce the content of choline in the tea drink, there is a method in which, for example, a cation which makes choline salt insoluble is added to precipitate and remove choline as a salt. Further, the content of choline can be also adjusted by reducing the content of choline by processing the tea extract liquid with the absorbent such as activated white earth, acid earth, activated carbon, an ion exchange resin, a chelate resin or the like. However, when the tea extract liquid is processed with an absorbent, not only choline but also caffeine or the like may be removed. In this case, it is desirable to adjust the content of caffeine and the content of choline within a range of a predetermined value by adding either one or both of the components as required.

As an choline salt capable of being added, for example, choline chloride can be used.

A ratio of the content of calcium to the content of choline in the tea drink of the invention, that is, the ratio of calcium to choline (hereinafter, it may also be expressed as “ratio of Ca to choline”) is within a range of from 3 to 65, preferably within a range of from 5 to 60, more preferably within a range of from 10 to 50, and still more preferably within a range of from 15 to 40.

The tea extract liquid used to manufacture the tea drink of the invention may be provided by adjusting the contents of polyphenol, caffeine, calcium, and choline contained in the tea drink of the invention by a process, though not particularly limited, such as a white earth process, an activated carbon process, and tea leaf boiling water treatment.

The pH in the tea drink of the invention can be maintained within the range of from 5.5 to 8.5, and preferably within the range of from 6.0 to 7.0. The pH of the tea drink and the tea extract liquid or its preparation can be measured using a commercially available pH meter. The pH in the tea drink of the invention can be adjusted by adding a pH adjuster acceptable for food to a preparation in which, for example, the tea extract liquid and the other component are blended. As an pH adjuster capable of being added, sodium hydrogen carbonate, sodium carbonate, potassium hydrogen carbonate, potassium carbonate, sodium hydroxide and potassium hydroxide can be used. Sodium hydrogen carbonate is preferably added from the viewpoint of flavor and cost.

In the tea drink of the invention, the content of polyphenol, the content of caffeine, and the ratio of calcium to choline in the tea drink are maintained within a range of a predetermined value, preferably, further, the content of calcium and content of choline are maintained within a range of a predetermined value, and still further, various optional components acceptable for food (for example, antioxidant, preservative, flavor) may be contained.

The tea drink of the invention can be provided in a form of a bottled drink. The tea drink of the invention is preferably a bottled tea drink. A container of the bottled drink means a closed container that can block a contact between the content and the external air, for example, a transparent container such as a PET bottle or a glass bottle, and a nontransparent container such as a canister or a paper container can be used. The tea drink of the invention is preferably bottled in a transparent or translucent PET bottle for demonstrating a color tone of the tea drink to a consumer through the container.

According to a preferable embodiment of the tea drink of the invention, provided is the tea drink containing at least polyphenol, caffeine and choline and bottled in a container, wherein the content of polyphenol contained in 100 mL of the tea drink is from 15 to 35 mg (preferably, 20 to 30 mg) in terms of tannins, the content of caffeine contained in 100 mL of the tea drink is 1.5 mg or less (preferably, 1.0 mg or less, and more preferably less than 1.0 mg), the ratio of calcium to choline contained in the tea drink is from 5 to 60 (preferably, 10 to 50).

According to another preferable embodiment of the tea drink of the invention, provided is the tea drink containing at least polyphenol, caffeine and choline and bottled in a container, wherein the content of polyphenol contained in 100 mL of the tea drink is from 15 to 35 mg (preferably, 20 to 30 mg) in terms of tannins, the content of caffeine contained in 100 mL of the tea drink is 1.5 mg or less (preferably, 1.0 mg or less, and more preferably less than 1.0 mg), the ratio of calcium to choline contained in the tea drink is from 5 to 60 (preferably, 10 to 50), the calcium contained in 1000 mL of the tea drink is from 1 to 20 mg (preferably 5 to 10 mg), and the choline contained in 1000 mL of the tea drink is from 0.05 to 1.0 mg (preferably 0.1 to 0.5 mg).

According to another embodiment of the invention, provided is a method of manufacturing a tea drink from tea extract liquid, comprising steps of:

adjusting the content of polyphenol in a tea extract liquid to a value corresponding to 10 to 40 mg in terms of tannins in 100 mL of the tea drink;

adjusting a content of caffeine in the tea extract liquid to a value corresponding to 2.0 mg or less in 100 mL of the tea drink; and

adjusting calcium and choline in a tea extract liquid such that the ratio of calcium to choline is 3 to 65 in the tea drink.

According to another preferable embodiment of the invention, provided is a manufacturing method of a tea drink from a tea extract liquid, comprising steps of: adjusting the content of polyphenol in the tea extract liquid to a value corresponding to 15 to 35 mg (preferably, 20 to 30 mg) in terms of tannins in 100 mL of the tea drink, adjusting the content of caffeine in the tea extract liquid to a value corresponding to 1.5 mg or less (preferably 1.0 mg or less, and more preferably less than 1.0 mg) in 100 mL of the tea drink, and adjusting the ratio of calcium to choline to 5 to 60 (preferably, 10 to 50) in the tea drink.

According to a still another preferable embodiment of the invention, provided is a manufacturing method of a tea drink from a tea extract liquid, comprising steps of: adjusting the content of polyphenol in the tea extract liquid to a value corresponding to 15 to 35 mg (preferably, 20 to 30 mg) in terms of tannins in 100 mL of the tea drink, adjusting the content of caffeine in the tea extract liquid to a value corresponding to 1. 5 mg or less (preferably 1.0 mg or less, and more preferably less than 1.0 mg) in 100 mL of the tea drink, adjusting the ratio of calcium to choline to 5 to 60 (preferably, 10 to 50) in the tea drink, adjusting the calcium in the tea extract liquid to a value corresponding to 1 to 20 mg (preferably 5 to 10 mg) in 1000 mL of the tea drink, and adjusting the choline in the tea extract liquid to a value corresponding to 0.05 to 1.0 mg (preferably 0.1 to 0.5 mg) in 1000 mL of the tea drink.

The polyphenol, caffeine, and choline used in the method of manufacturing of the tea drink of the invention may be the same as those in the tea drink of the invention, and, the contents of the polyphenol, caffeine and choline in the tea drink can be adjusted according to the above description.

According to a another embodiment of the invention, the tea drink manufactured according to the manufacturing method of the tea drink of the invention is provided. The manufacturing method of the tea drink of the invention may be any one of the above-described manufacturing methods.

According to another embodiment of the invention, provided is a method of improving an after-astringency of a tea drink, comprising steps of:

adjusting the content of polyphenol in a tea extract liquid to a value corresponding to 10 to 40 mg in terms of tannins in 100 mL of the tea drink;

adjusting the content of caffeine in the tea extract liquid to a value corresponding to 2.0 mg or less in 100 mL of the tea drink; and

adjusting calcium and choline such that the ratio of calcium to choline in a tea extract liquid is 3 to 65 in the tea drink.

According to another preferable embodiment of the invention, provided is a method of improving an after-astringency of a tea drink, comprising steps of:

adjusting the content of polyphenol in a tea extract liquid to a value corresponding to 15 to 35 mg (preferably 20 to 30 mg) in terms of tannins in 100 mL of the tea drink;

adjusting the content of caffeine in the tea extract liquid to a value corresponding to 1.5 mg or less (preferably 1.0 mg or less, and more preferably less than 1.0 mg,) in 100 mL of the tea drink; and

adjusting calcium and choline such that the ratio of calcium to choline in a tea extract liquid is 5 to 60 (preferably 10 to 50) in the tea drink.

According to a still another preferable embodiment of the invention, provided is a method of improving after-astringency of the tea drink, comprising steps of: adjusting the content of polyphenol in the tea extract liquid to a value corresponding to 15 to 35 mg (preferably, 20 to 30 mg) in terms of tannins in 100 mL of the tea drink, adjusting the content of caffeine in the tea extract liquid to a value corresponding to 1.5 mg or less (preferably 1.0 mg or less, and more preferably less than 1.0 mg) in 100 mL of the tea drink, adjusting the calcium and choline in the tea extract liquid such that the ratio of calcium to choline may be 5 to 60 (preferably, 10 to 50) in the tea drink, adjusting the calcium in the tea extract liquid to a value corresponding to 1 to 20 mg (preferably 5 to 10 mg) in 1000 mL of the tea drink, and adjusting the choline in the tea extract liquid to a value corresponding to 0.05 to 1.0 mg (preferably 0.1 to 0.5 mg) in 1000 mL of the tea drink.

The method of improving after-astringency of the tea drink of the invention may be a method of improving the bitterness of the tea drink.

The polyphenol, caffeine, and choline used in the method of improving the after-astringency and bitterness of the tea drink of the invention may be the same as those in the tea drink of the invention, and, the contents of the polyphenol, caffeine and choline in the tea drink can be adjusted according to the above description.

The after-astringency in the method of improving the after-astringency of the tea drink of the invention is the astringency sensed after drinking tea drink, and means a flavor giving thickness and lingeringness to the taste of the tea drink, means the astringency sensed at, for example, 5 to 30 seconds after drinking tea drink, and preferably means the astringency sensed at 5 seconds after drinking of the tea drink. The “improvement of the after-astringency” in the method of improving the after-astringency of the tea drink of the invention may be any embodiment as long as the reduction of the astringency sensed after drinking tea drink can be suppressed, means suppression of reduction of the astringency sensed at, for example, 5 to 30 seconds after drinking tea drink, and preferably means suppression of reduction of the astringency sensed at 5 seconds after drinking tea drink.

### EXAMPLES

Hereinafter, the present invention will be described in more detail with reference to examples. However, technical scope of the present invention are not limited to these illustrations. It should be noted that in the following examples, unless particularly mentioned, “%” means % by mass.

### Measurement Method of Caffeine

The content of caffeine in the tea drink was analyzed according to the following procedure.

A tea drink was filtered with a membrane filter (DISMIC, hydrophilic PTFE, 0.45 μm, manufactured by Advantech Co., Ltd.), and the content of caffeine was quantified according to a high-performance liquid chromatography (HPLC) method shown in following Table 1. Conditions of the HPLC analysis are shown in following Table 1.

TABLE 1
Conditions of High-Performance Liquid
Chromatography (HPLC) Analysis

| Apparatus | HPLC manufactured by JASCO Corporation | | |
|---|---|---|---|
| Column | CAPCELL PAK C18 UG120 4.6 mm × 250 mm | | |
| | (manufactured by Shiseido Co., Ltd.) | | |
| Oven | 40° C. | | |
| temperature | | | |
| Mobile phase | A Liquid) 0.1% phosphoric acid solution | | |
| | containing 5% N,N-dimethylformamide | | |
| | B Liquid) acetonitrile | | |
| Gradient | Time | Composition ratio (%) | |
| condition | (minute) | A Liquid | B Liquid |
| | 0 | 98 | 2 |
| | 20 | 88 | 12 |
| | 35 | 60 | 40 |

| | |
|---|---|
| Flow rate | 1.0 mL/min |
| Detection | UV (280 nm) |
| Injection amount | 10 μL |

### Measurement Method of Calcium

The content of calcium in the tea drink was analyzed according to the following procedure.

A tea drink was filtered with a membrane filter (DISMIC, hydrophilic PTFE, 0.45 μm, manufactured by Advantech Co., Ltd.), and the content of calcium was quantified according to an ion chromatography method. Conditions of the ion chromatography analysis are shown in following Table 2.

TABLE 2
Conditions of Ion Chromatography analysis

| | |
|---|---|
| Apparatus | Ion Chromatograph manufactured |
| | by Shimadzu Corporation |
| Column | ShimPack IC-C4 |
| | (manufactured by |
| | Shimadzu GLC Ltd.) |
| Oven temperature | 40° C. |
| Mobile phase | 3 mM oxalic acid |
| Flow rate | 1 mL/min |
| Detection | Electric conductivity detector |
| Injection amount | 1500 μL |

### Measurement Method of Choline

The content of choline in the tea drink was analyzed according to the following procedure.

A tea drink diluted with ultrapure water was filtrated with a filter (0.2 μm) and the content of choline was quantified according to a high-performance liquid chromatography-mass spectrometry. The apparatus and measurement conditions used are as shown below.

TABLE 3
Conditions of High-Performance Liquid
Chromatography-Mass Spectrometry

| High- | Apparatus | ACQUITY UPLC | |
|---|---|---|---|
| performance | | (manufactured by Waters) | |
| liquid | A Liquid | Ultrapure aqueous solution | |
| chromatogram | | containing 0.1% of formic acid | |
| | | and 10 mM of ammonium formate | |
| | B liquid | Acetonitrile solution containing | |
| | | 0.1% of formic acid, ammonium | |
| | | formate and 9.9% of ultrapure | |
| | | water | |
| | Flow rate | 0.4 | |
| | (mL/min) | | |
| | Column | ACQUITY UPLC BEH Amide | |
| | | (2.1 mmφ × 50 mm, 1.7 mm) | |
| | | (manufactured by Waters) | |
| | Column | 60 | |
| | temperature | | |
| | (° C.) | | |
| | Injection | 2 | |
| | amount (·I) | | |
| | Sample | 10 | |
| | temperature | | |
| | (° C.) | | |
| | Gradient | Time (min) | B(%) |
| | | Start | 100 |
| | | 0.5 | 100 |
| | | 10 | 50 |
| | | 15 | 50 |
| | | 15.1 | 100 |
| | | 22 | 100 |
| Mass | Equipment | Xevo TQ-S | |
| spectrometer | | (manufactured by Waters) | |
| | MRM | Precursor ion | Production |
| | | 104 | 59.7 |

### Reference Example

### After-Astringency in Refreshing Tea Drink Having Relatively Slight Bitterness and Astringency

### (1) Preparation of Green Tea Extract Liquid

To 100 g of steamed green tea leaves, 4000 g of hot water at 70° C. was added, and an extraction was performed for 6 minutes. After the extraction, a solid-liquid separation was performed, and after cooling the filtrate to 20° C., ion exchange water was added to the filtrate until the mixture became 4000 g, and centrifugal separation was performed to obtain a green tea extract liquid.

### (2) Preparation of Activated Carbon Treated Liquid

Four grams of the activated carbon (FP-3, manufactured by Japan EnviroChemicals Limited) were added to 400 g of the green tea extract liquid obtained and kept in contact therewith for a predetermined time (for 1 to 10 minutes) at room temperature. After the contact, centrifugal separation was performed, the separated liquid was filtered using a 0.2 μm membrane filter, and an activated carbon treated liquid was obtained.

### (3) Preparation of Green Tea Drink

To the activated carbon treated liquid obtained, caffeine (manufactured by Shiratori Pharmaceutical Co., Ltd.) was added such that the content of caffeine became 5 mg/100 mL or 10 mg/100 mL, further, polyphenol (Polyphenon 70A, manufactured by Mitsui Norin Co., Ltd.) was appropriately added such that the amount of tannins became 50 mg/100 mL or 25 mg/100 ml respectively, still further, 400 mg of L-ascorbic acid was added, and after adjusting the pH to 6.5 with sodium hydrogen carbonate, ion exchange water was added until the mixture became 1000 g, yielding green tea drinks of test sections 1 to 6.

### (4) Flavor Evaluation

A sensory evaluation of the green tea drinks obtained was performed by 5 trained testers. In a flavor evaluation, using a test section 1 as a control (four points of four point full mark) of test sections 2 and 3, and with a test section 4 as a control (four points of four point full mark) of test sections 5 and 6. The green tea drinks were evaluated on the degree of bitterness and after-astringency that are components of the flavor of the green tea drink and an overall flavor. That is, evaluation raw scores are as shown below: four points means “comparable with the control”, three point means “a little weaker than or inferior to the control”, two point means “clearly weaker than or inferior to the control”, and one point means “remarkably weaker than or inferior to the control”.

The evaluation raw scores were further divided into levels based on the following evaluation criteria. The evaluation criteria of the flavor are as follows: a symbol “⊚” (double circle) represents the flavor closest to the control sample, and in the order of symbols “◯” (circle), “Δ” (triangle), and “×” (cross), change of the flavor from the control sample becomes larger.

It should be noted that the after-astringency was evaluated as the bitterness sensed at 5 seconds after drinking the tea drink (the same shall apply hereinafter).

### Evaluation Criteria

⊚ (double circle): (3.5 point or more in four grade evaluation)
◯ (circle): (3 point or more and less than 3.5 point in four grade evaluation)
Δ (triangle): (2.5 point or more and less than 3 point in four grade evaluation)
× (cross): (less than 2.5 point in four grade evaluation)

### (5) Results of Evaluation

Evaluation results of the flavor of the respective green tea drinks and their amount of tannin, contents of caffeine, calcium (Ca), and choline, and ratios of calcium (Ca) to choline are shown in following Table 4.

TABLE 4
Results of evaluation

| | Amount of | Content of | Content of | Content of | | | | |
|---|---|---|---|---|---|---|---|---|
| | tannins | caffeine | calcium | choline | Ratio of | | After- | Overall |
| | (mg/100 mL) | (mg/100 mL) | (mg/L) | (mg/L) | Ca/choline | Bitterness | astringency | evaluation |
| Test | 50 | 10 | 1.38 | 1.5 | 1.15 | ⊚ | ⊚ | ⊚ |
| section 1 | | | | | | | | |
| Test | 50 | 5 | 1.38 | 1.5 | 1.15 | ◯ | ◯ | ◯ |
| section 2 | | | | | | | | |
| Test | 50 | 0 | 1.38 | 1.5 | 1.15 | Δ | ◯ | ◯ |
| section 3 | | | | | | | | |
| Test | 25 | 10 | 0.69 | 0.73 | 0.95 | ⊚ | ⊚ | ⊚ |
| section 4 | | | | | | | | |
| Test | 25 | 5 | 0.69 | 0.73 | 0.95 | ◯ | Δ | Δ |
| section 5 | | | | | | | | |
| Test | 25 | 0 | 0.69 | 0.73 | 0.95 | Δ | X | X |
| section 6 | | | | | | | | |

Overall flavor evaluation results (overall evaluation) were deteriorated by the reduction of the after-astringency caused by an activated carbon process, which removed caffeine, exhibiting bitterness, resulting in the reduction of after-astringency as well as bitterness. In the test sections 2 and 3 in which the amount of tannins was about 50 mg/100 ml, the after-astringency become weak to some extent because of the caffeine concentration decrease compared with the test section 1 (control). However, in the test sections 5 and 6, tea drinks having the amount of tannins of about 25 mg/100 ml, a relatively small amount of polyphenol and a refreshed flavor, it was found that the after-astringency was remarkably weakened due to the decrease in the caffeine concentration compared with the test section 4 (control). From the above, it was found that the degree of the after-astringency sensed at 5 seconds after drink varies in coordination with the caffeine concentration particularly in the tea drink containing a relatively small amount of polyphenol and having a refreshing flavor.

### Test Example

### Improvement of Bitterness and After-Astringency of Tea Drinks that are Adjusted within Predetermined Ranges by Various Kinds of Processes

### (1) Preparation of Green Tea Extract Liquid

To 100 g of steamed green tea leaves, 4000 g of hot water at 70° C. was added, and extraction was performed for 6 minutes. After the extraction, solid-liquid separation was performed, and after cooling the filtrate to 20° C., ion exchange water was added to the filtrate until the mixture became 4000 g, and centrifugal separation was performed to obtain a green tea extract liquid.

### (2) Preparation of Activated Carbon Treated Green Tea Extract Liquid

To 300 g of the green tea extract liquid obtained, activated carbons (FP-1, FP-3: manufactured by Japan EnviroChemicals Limited, CL-K: manufactured by Ajinomoto Fine-Tehno Co., Inc.) were added according to the absorbent concentrations described in Table 5 and kept in contact therewith for a predetermined time (1 to 10 minutes) at room temperature. After the contact, centrifugal separation was performed, the separated liquid was filtered using a 0.2 μm membrane filter, and an activated carbon treated liquid was obtained.

### (3) Preparation of White Earth Treated Green Tea Extract Liquid

After setting 300 g of the green tea extract liquid obtained to room temperature (25° C.), acid earth (MIZUKA Ace #200, manufactured by Mizusawa Industrial Chemicals, Ltd.) was added according to the absorbent concentrations described in Table 5 and kept in contact therewith for a predetermined time (for 10 seconds to 10 minutes). At the same time with the lapse of the predetermined time, centrifugal was applied and the separated liquid was filtered using a 0.2 μm membrane filter.

### (4) Preparation of Green Tea Drink

To the filtrates obtained, 400 mg of L-ascorbic acid was added, and, after adjusting the pH to 6.5 with sodium hydrogen carbonate, the mixture was made to 1000 g by adding ion exchange water, yielding the tea drinks of test sections 7 to 24.

The test section 7 is a group that was not treated with the absorbent. However, the test section 7 was subjected to the operation the same as the test sections 8 to 24 except that it was not treated with the absorbent.

### (4) Evaluation

Regarding the green tea drinks obtained, the caffeine concentrations were measured using high-performance liquid chromatograph (HPLC: JASCO Corporation), the calcium concentrations were measured according to an ion chromatography, respectively, and the test results are shown in Table 5. Further, the “bitterness”, “after-astringency” and “overall evaluation” of the green tea drinks were evaluated by 5 trained testers in the same manner as in the evaluation of flavor of the above reference example. The control was assigned to the test section 7. The results of evaluations of the flavor are shown in following Table 6.

TABLE 5
Analysis results of tea drinks

| | Absorbent used for green tea | | | | | | | |
|---|---|---|---|---|---|---|---|---|
| | extraction process | | | Amount of | Content of | Ca | Content | |
| Test | | Product | Concentration | tannins | caffeine | Content | of choline | Ratio of |
| section | Type | name | (%) | (mg/100 mL) | (mg/100 mL) | (mg/L) | (mg/L) | Ca/choline |
| 7 | — | — | — | 35.41 | 7.73 | 0.97 | 1.04 | 0.94 |
| 8 | Acid | #200 | 0.5 | 37.54 | 3.54 | 3.40 | 0.71 | 4.82 |
| 9 | earth | | 1 | 35.15 | 2.06 | 4.44 | 0.32 | 13.94 |
| 10 | | | 2 | 32.31 | 0.95 | 5.68 | 0.23 | 25.09 |
| 11 | | | 3 | 33.29 | 0.60 | 7.33 | 0.17 | 43.43 |
| 12 | | | 4 | 31.40 | 0.49 | 8.96 | 0.15 | 60.65 |
| 13 | | | 5 | 33.47 | 0.45 | 9.91 | 0.14 | 69.52 |
| 14 | | K type | 0.5 | 36.64 | 3.86 | 1.04 | 0.77 | 1.34 |
| 15 | | #200 | 2 | 35.64 | 0.21 | 1.01 | 0.21 | 4.78 |
| 16 | | Ca type | 0.5 | 36.59 | 2.90 | 5.00 | 0.55 | 9.04 |
| 17 | | #200 | 2 | 34.89 | 0.59 | 15.24 | 0.25 | 61.02 |
| 18 | Activated | FP-1 | 0.2 | 30.88 | 4.37 | 1.15 | 1.07 | 1.08 |
| 19 | carbon | | 0.5 | 21.07 | 1.29 | 1.09 | 1.01 | 1.08 |
| 20 | | | 2 | 0.89 | 0.00 | 1.02 | 0.52 | 1.98 |
| 21 | | FP-3 | 0.2 | 33.09 | 2.76 | 1.22 | 1.02 | 1.20 |
| 22 | | | 0.5 | 26.02 | 0.35 | 1.14 | 0.94 | 1.21 |
| 23 | | | 2 | 5.56 | 0.07 | 1.17 | 0.64 | 1.82 |
| 24 | | CL-K | 2 | 12.57 | 1.34 | 1.26 | 0.59 | 2.12 |

TABLE 6
Results of flavor evaluation

| Test | | After- | Overall |
|---|---|---|---|
| section | Bitterness | astringency | evaluation |
| 7 | ⊚ | ⊚ | ⊚ |
| 8 | ◯ | Δ | Δ |
| 9 | ◯ | ⊚ | ⊚ |
| 10 | ◯ | ⊚ | ⊚ |
| 11 | ◯ | ⊚ | ⊚ |
| 12 | ◯ | Δ | Δ |
| 13 | ◯ | X | X |
| 14 | ◯ | X | X |
| 15 | Δ | Δ | Δ |
| 16 | ◯ | ◯ | ◯ |
| 17 | Δ | Δ | Δ |
| 18 | Δ | X | X |
| 19 | X | X | X |
| 20 | X | X | X |
| 21 | Δ | X | X |
| 22 | X | X | X |
| 23 | X | X | X |
| 24 | X | X | X |

In the green tea drink in which the amount of tannins is 10 to 40 mg/100 ml and the content of caffeine is reduced to 2.0 mg/100 ml or less, it became clear that the after-astringency is more enhanced when the ratio of calcium to choline is in the range of from 3 to 65 than when the ratio of calcium to choline is not in that range. Further, when the ratio of calcium to choline is in the range of from 5 to 60, it became clear that the after-astringency became closer to the after-astringency of the control green tea drink that was not subjected to the absorbent process. Still further, when the ratio of calcium to choline is in the range of from 10 to 50, it became clear that the after-astringency became further closer to the after-astringency of the control green tea drink that was not subjected to the absorbent process, and the after-astringency was improved.

1. A tea drink comprising at least polyphenol, calcium and choline,
wherein the content of the polyphenol contained in 100 mL of the tea drink is 10 to 40 mg in terms of tannins,
wherein the content of caffeine contained in 100 mL of the tea drink is 2.0 mg or less, and
wherein the ratio of calcium to choline contained in the tea drink is 3 to 65.

2. The tea drink according to claim 1, wherein the content of calcium contained in 1000 mL of the tea drink is 0.1 to 30 mg.

3. The tea drink according to claim 1, wherein the content of choline contained in 1000 mL of the tea drink is 0.01 to 5.0 mg.

4. The tea drink according to claim 1, wherein the pH of the tea drink is 5.5 to 8.5.

5. The tea drink according to claim 1, wherein the tea drink is a green tea drink.

6. The tea drink according to claim 1, wherein the tea drink is a packaged tea drink.

7. A method of manufacturing a tea drink from a tea extract liquid, comprising the steps of:
adjusting the content of polyphenol in the tea extract liquid to a value corresponding to 10 to 40 mg in terms of tannins in 100 mL of the tea drink;
adjusting the content of caffeine in the tea extract liquid to a value corresponding to 2.0 mg or less in 100 mL of the tea drink; and
adjusting calcium and choline in the tea extract liquid such that the ratio of calcium to choline is 3 to 65 in the tea drink.

8. A tea drink manufactured by the method according to claim 7.

9. A method of improving after-astringency of a tea drink, characterized in that the content of polyphenol in a tea extract liquid is adjusted to a value corresponding to 10 to 40 mg in terms of tannins in 100 mL of the tea drink, the content of caffeine in the tea extract liquid is adjusted to a value corresponding to 2.0 mg or less in 100 mL of the tea drink, and calcium and choline in the tea extract liquid are adjusted such that the ratio of calcium to choline is 3 to 65 in the tea drink.
